(19) United States
(12) Patent Application Publication
(10) Pub. No.: US 2010/0058981 A1
(43) Pub. Date: Mar. 11, 2010

(54) FILM COATING APPARATUS

(75) Inventor: SHAO-KAI PEI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/494,280

(22) Filed: Jun. 30, 2009

(30) Foreign Application Priority Data
Sep. 8, 2008 (CN) 200810304406.3

(51) Int. Cl. B05B 7/00

(52) U.S. Cl. 118/300

(57) ABSTRACT

A film coating apparatus for coating a substrate includes a number of film coating units. Each film coating unit includes a container, a transfer roller, a liquid jet, and a heater. The container is used for receiving coating liquid. The coating liquid includes coating material. The transfer roller is capable of conveying the substrate. The liquid jet is configured for jetting coating liquid received in the container toward the transfer roller. The heater is used for heating the coating liquid on the substrate to solidify the coating material of the coating liquid on the substrate to form films.

### BACKGROUND

1. Technical Field

The present disclosure relates to film coating apparatuses and, particularly, to a film coating apparatus for coating multiple films on a substrate.

2. Description of Related Art

A typical film coating apparatus usually needs to change types of coating material when coating multiple films. During the multi-film coating process, the film coating apparatus usually needs to stop coating and wait for changing coating materials. Accordingly, the film coating efficiency of the film coating apparatus is decreased.

What is needed, therefore, is a film coating apparatus to overcome or at least mitigate the above-described problem.

### BRIEF DESCRIPTION OF THE DRAWINGS

Many aspects of the present film coating apparatus can be better understood with reference to the accompanying drawings. The components in the drawings are not necessarily drawn to scale, the emphasis instead being placed upon clearly illustrating the principles of the present film coating apparatus. In the drawings, all the views are schematic.

FIG. 1 is a schematic view of a film coating apparatus according to an exemplary embodiment.

FIG. 2 is a schematic view of the film coating apparatus of FIG. 1 in a working state.

### DETAILED DESCRIPTION

Embodiments of the present disclosure will now be described in detail below, with reference to the accompanying drawings.

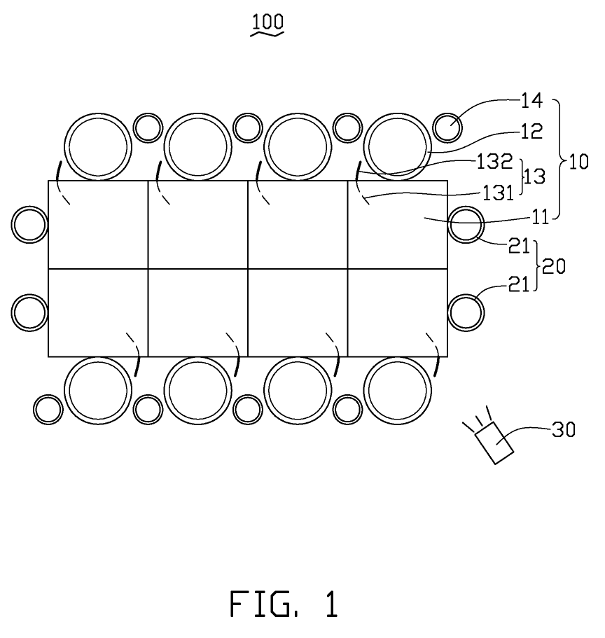

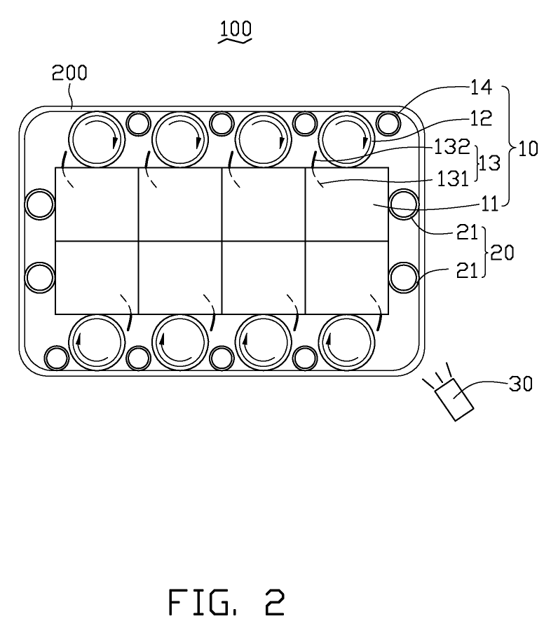

Referring to the FIG. 1 and FIG. 2, a film coating apparatus 100 for coating a multiple films on a substrate 200, according to an exemplary embodiment, is shown. The film coating apparatus 100 includes a number of film coating units 10, a cooling unit 20, and a detecting unit 30.

Each film coating unit 10 includes a container 11, a transfer roller 12, a liquid jet 13, and a heater 14.

The container 11 receives coating liquid (not shown) therein. The coating liquid can be a liquid state coating material or a coating material containing solution. The liquid state coating material can be a thermosetting resin, such as polyimide resin (PI), epoxy resin, phenol resin, etc. The coating material solution can be consisting of coating material and solvent for solving the coating material.

The liquid jet 13 is used for jetting coating liquid toward the transfer roller 12. The liquid jet 13 includes an inlet end 131 and an outlet end 132. The inlet end 131 is submerged in the coating liquid which is received in the container 11. The outlet end 132 faces towards the transfer roller 12.

The transfer roller 12 rotates contacting with the substrate 200 and conveys the substrate 200. Thus, the coating liquid jetted on the transfer roller 12 can be transferred to the substrate 200. The transfer roller 12 can be made of alumina, ceramic, or stainless steel.

The heater 14 is used for heating the coating liquid on the substrate 200 to solidify the coating material of the coating liquid on the substrate 200 to form films. In the present embodiment, the heater 14 is a heating roller which rolling axis is parallel to that of the transfer roller 12. In each film coating unit 10, the heater 14 is arranged to make the substrate 200 can contact with the transfer roller 12 first, and then contact with the heater 14.

In the present embodiment, the film coating apparatus 100 includes eight film coating units 10. The transfer rollers 102 of the eight film coating units 10 are parallel to each other. The transfer rollers 102 of the eight film coating units 10 are arranged in two rows, with four rollers 102 to a row. Up to eight different kinds of coating material can be apportioned to the containers 11 of the eight film coating units 10.

In the film coating apparatus 100, the containers 11 of the film coating units 10 can receive different kinds of coating liquid. By selectively turning on the liquid jets 13, the film coating apparatus 100 can coat a variety of films on the substrate 200. For example, when operators want to coat a first film using a first coating liquid, the liquid jets/jet 13 corresponding to the containers/container receiving the first coating liquid will be turned on, and the other liquid jets/jet 13 will be turned off. When the operators want to coat a second film using a second coating liquid, the liquid jets/jet 13 corresponding to the containers/container receiving the second coating liquid will be turned on, and the other liquid jets/jet 13 will be turned off. Therefore, during a multi-film coating process, the film coating apparatus 100 can coat films by turning on corresponding liquid jets/jet 13, and does not need to stop coating while coating materials are changed out. Accordingly, the film coating efficiency of the film coating apparatus 100 is relatively higher.

The cooling unit 20 is used for cooling the films formed on the substrate 200. The detecting unit 30 is configured for detecting the thickness of the film formed on the substrate 200. Operators can determine which liquid jet/jets to turn on or off by the detecting result of the detecting unit 30. Preferably, the films on the substrate 200 are measured by the detecting unit 30 after being cooled by the cooling unit 20. In the present embodiment, the cooling unit 20 includes a number of cooling rollers 21.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A film coating apparatus for coating a substrate comprising:
a plurality of film coating units, each film coating unit comprising:
a container for receiving coating liquid, the coating liquid comprising coating material;
a transfer roller configured for conveying the substrate;
a liquid jet for jetting coating liquid received in the container toward the transfer roller; and
a heater used for heating the coating liquid on the substrate to solidify the coating material of the coating liquid on the substrate to form films.

2. The film coating apparatus of claim 1, further comprising a cooling unit for cooling the films on the substrate.

3. The film coating apparatus of claim 1, further comprising a detecting unit for detecting the thickness of the film formed on the substrate.

4. The film coating apparatus of claim 2, further comprising a detecting unit for measuring the thickness of the film which is cooled by the cooling unit.

5. The film coating apparatus of claim 1, wherein the coating liquid is a liquid state coating material or a coating material containing solution.

6. The film coating apparatus of claim 5, wherein the liquid jet comprises an inlet end and an outlet end, the inlet end is submerged in the coating liquid received in the container, and the outlet end faces towards the transfer roller.

7. The film coating apparatus of claim 5, wherein the transfer roller is made of aluminum, ceramic, or stainless steel.

8. The film coating apparatus of claim 1, wherein the heater is a heating roller.

9. The film coating apparatus of claim 8, wherein a rolling axis of the heating roller is parallel to that of the transfer roller.

10. The film coating apparatus of claim 2, wherein the cooling unit comprises a number of cooling rollers.
